(19) United States
(12) Patent Application Publication
(10) Pub. No.: US 2026/0145856 A1
(43) Pub. Date: May 28, 2026

(54) DEVICE, METHOD AND CLUSTER FOR DISPENSING LIQUID TO A WATER-SOLUBLE POUCH AND MACHINE FOR FORMING AND FILLING WATER SOLUBLE POUCHES

(71) Applicant: MESPACK S.L., Santa Perpetua de Mogoda (ES)

(72) Inventors: Gavin Patrick SMITH, Elmhurst, IL (US); Donn D. HARTMAN, Hawthorn Woods, IL (US); Tony LOIACONO, Schaumburg, IL (US); Russell MILLER, Des Plaines, IL (US)

(21) Appl. No.: 18/956,105

(22) Filed: Nov. 22, 2024

(51) Int. Cl. B65D 75/58; B67D 1/00; B67D 7/02

(52) U.S. Cl. CPC B65D 75/5822; B65D 75/5811; B67D 1/0001; B67D 7/0216

(57) ABSTRACT

A device for dispensing liquid to a water-soluble pouch comprising a fluid inlet, a fluid outlet, an elongated body defining a longitudinal axis of the device, and a fluidly actuated valve for opening and closing the fluid outlet. The elongated body comprises a fluid passage extending from the fluid inlet to the fluid outlet. The valve comprises a fluid cylinder housed in the elongated body. The fluid inlet, the fluid passage, the fluid cylinder and the fluid outlet are axially arranged with respect to the longitudinal axis, and the fluid passage defines a fluid chamber having an inlet and an outlet that encloses the fluid cylinder.

A method for dispensing liquid to water soluble pouches, a cluster of two or more devices for dispensing liquid to water soluble pouches and a machine for forming and filing pouches made of water-soluble film.

### TECHNICAL FIELD

The present invention relates to a device and a method for dispensing liquid to water soluble pouches. The present invention also relates to a cluster of two or more devices for dispensing liquid to water soluble pouches and to a machine for forming and filing pouches made of water-soluble film.

### BACKGROUND OF THE INVENTION

Pouches made of water-soluble film filled with liquid, or with a combination of liquid, powder and/or solid in case of multicompartment pouches, are known in the art. Liquid filled pouches or compartments are typically filled by devices for dispensing liquid to such water-soluble pouches or compartments thereof. Said devices for dispensing liquid to water soluble pouches are commonly known as nozzles. Said water soluble film is typically made of polyvinyl alcohol (PVOH), although other water-soluble materials can also be used.

In case of water-soluble pouches having multiple compartments, typically each compartment comprises or houses a different product or material. Each compartment of a water-soluble pouch is typically filled with a corresponding device for dispensing the corresponding liquid, powder or solid. As the water-soluble pouches are typically of reduced dimensions, and the product needs to be dispensed within the size limits of the pouches, said devices for dispensing the products to be introduced in the corresponding compartments of water-soluble pouches, need to be clustered, i.e., placed close to one another, in a tight space, thereby resulting in complex arrangements of dispensing devices. The complexity of the clusters of dispensing devices typically increases with an increase of the number of compartments in the water-soluble pouches.

Each dispensing device has a certain footprint, i.e., each device covers or uses a certain area, and, as a general rule, the smaller the footprint of a dispensing device, the easier it is to cluster said dispensing device with other dispensing devices, of the same or different kind. Also, the easier it is to cluster dispensing devices that usually operate simultaneously, the easier is to make and fill pouches, especially multicompartment pouches, with complex geometries. Therefore, a reduced footprint is typically a desired feature of any dispensing device to be used for filling pouches, in particular, in the case of multi compartment pouches. However, the aim of a reduced footprint has to be balanced with the operational requirements of the dispensing device, that in modern equipment, needs to be able to dispense a precise dose, at high speeds, without dripping product to be dosed, with a long lifespan, simple maintenance, etc.

It is an aim of the present invention to provide a device for dispensing liquid to water soluble pouches having a reduced footprint when compared to other devices known in the art, while providing a high dosing speed, with high precision and with a long lifespan of its components. Dispensing devices known in the art, typically have a fluid inlet arranged radially with respect to a longitudinal axis of the dispensing device and also suffer from overheating due to the high speed at which their internal components operate, generating heat that is not effectively dissipated. The present invention aims to overcome both problems.

U.S. Pat. No. 5,277,342 A discloses a dispensing apparatus capable of dispensing a wide variety of fluids, such as adhesives. The dispensing apparatus disclosed by U.S. Pat. No. 5,277,342 A includes a cylindrical housing in which a slide is mounted. The housing includes a fluid reservoir which is supplied with pressurized fluid. A longitudinal passage extends through the slide for providing this fluid to the reservoir. A bellow seal is employed for sealing off an actuating mechanism from the reservoir. The seal is connected between the slide and a support fixedly mounted to the housing. A valve mechanism is provided at one end of the housing for controlling the flow of fluid from the reservoir. The valve mechanism is directly or indirectly responsive to the slide. Fluid may be caused to flow through the valve mechanism either by fluid pressure or by positive displacement.

The dispensing apparatus disclosed by U.S. Pat. No. 5,277,342 A is designed to be manually operated, thereby making it unsuitable for use in industrial applications requiring high speed dosing, such as the filing of water-soluble pouches.

U.S. Pat. No. 5794825 A discloses an applicator which is sealed to a very high degree against any ingress of air and is therefore suitable for use with adhesives which react strongly with air. The applicator comprises a housing having a bore terminating at one end in an outlet aperture, a plunger received in said bore and mounted for movement between an open position and a closed position, the rear end of the plunger projecting from the other end of the housing, the plunger including a longitudinal bore for supply of liquid to be applied, the plunger being provided with one or more ports through which liquid may flow from the bore of the plunger into the bore of the housing so arranged that when the plunger is in the fully open position the bore of the housing and the bore of the plunger co-operate to provide a streamlined flow path, means for moving the plunger between the closed position and the open position; and a seal between plunger and housing to prevent ingress of air. In the fluid applicator disclosed by U.S. Pat. No. 5,794,825 A the seal is a liquid barrier seal and in the closed position a forward end of the plunger seals said housing outlet aperture and in the open position the forward end of the plunger is retracted into the housing.

The plunger of the applicator disclosed by U.S. Pat. No. 5,794,825 A is pneumatically driven to an open position and is returned to a closed position by a compression spring, which results in an increased productivity when compared to the dispensing apparatus disclosed by U.S. Pat. No. 5,277,342 A, but still insufficient for the modern productivity requirements in industrial manufacture of water-soluble pouches. Additionally, the applicator disclosed by U.S. Pat. No. 5,794,825 A does not address the possible overheating of the plunger due to operation.

U.S. Pat. No. 5,735,434 A discloses a dispensing apparatus for dispensing a material, the dispensing apparatus including a valve assembly comprising: a valve member movable in a reciprocating fashion along an axis, where the valve member includes a stem having at least one material transfer recess provided on the stem and a tapered dispensing end having an angle of taper. The valve member disclosed by U.S. Pat. No. 5,735,434 A is movable between a first position where a discrete toroidal mass of material to be dispensed is formed at the dispensing end and a second position where a discrete toroidal mass of material to be dispensed is not formed at the dispensing end. The dispensing apparatus also includes a material dispensing assembly having a fluid knife for moving the discrete toroidal mass to be dispensed from the dispensing end away from the dispensing end when the valve member is in the first position. The fluid knife is supplied substantially parallel to the angle of taper of the dispensing end. According to U.S. Pat. No. 5,735,434 A, the valve assembly is generally a pneumatic valve assembly and the pressurized fluid for actuating the piston valve and assembly may be air, a hydraulic fluid or any other suitable fluid.

In the dispensing apparatus disclosed by U.S. Pat. No. 5,735,434 A, the fluid supply line is perpendicular to the longitudinal axis of the dispensing apparatus, and thus, the fluid has to make a 90 degrees turn, which results in an increased pressure drop along the flow path. Additionally, the pneumatic valve assembly of the dispensing apparatus disclosed by U.S. Pat. No. 5,735,434 A is cooled solely by ambient air.

It is also an aim of the invention to provide a method for dispensing liquid to water soluble pouches, as well as a cluster of two or more devices for dispensing liquid and a machine for forming and filing pouches made of water-soluble film.

### SUMMARY

According to a first aspect of the present invention, it is disclosed a device for dispensing liquid to a water-soluble pouch comprising: a fluid inlet; fluid outlet; an elongated body defining a longitudinal axis of the device, the elongated body having a fluid passage therein extending from the fluid inlet to the fluid outlet; a fluidly actuated valve for opening and closing the fluid outlet, the valve having a fluid cylinder housed in the elongated body and having a valve closing inlet and a valve opening inlet; wherein the fluid inlet, the fluid passage, the fluid cylinder and the fluid outlet are axially arranged with respect to the longitudinal axis; and wherein the fluid passage defines a fluid chamber, having an inlet and an outlet, enclosing the fluid cylinder.

According to the first aspect of the present invention, the fluidly actuated valve may be a pneumatically actuated valve or a hydraulically actuated valve. In embodiments having a pneumatically actuated valve, the fluid cylinder is a pneumatic cylinder and the valve opening and valve closing inlets are pressurized gas inlets. In embodiments having a hydraulically actuated valve, the fluid cylinder is a hydraulic cylinder and the valve opening and valve closing inlets are pressurized liquid inlets.

According to the first aspect of the present invention, the inlet and the outlet of the fluid chamber may be fluidly connected by one or more longitudinal conduits arranged around the fluid cylinder. Preferably, the one or more longitudinal conduits laterally face the fluid cylinder.

According to the first aspect of the present invention, the fluid chamber may comprise an upstream facing surface and a downstream facing surface, the one or more longitudinal conduits extending from the upstream facing surface to the downstream facing surface.

According to the first aspect of the present invention, the upstream facing surface and/or the downstream facing surface may comprise a flat region arranged substantially perpendicular to the longitudinal axis. Said flat region may extend over all or part of the upstream facing surface and/or the downstream facing surface.

According to the first aspect of the present invention, the upstream facing surface and/or the downstream facing surface may comprise a protruding region axially arranged with respect to the longitudinal axis. Preferably, the protruding region is conically or frustoconically shaped, although other shapes are also possible. The protruding region is preferably shaped to help maintain a laminar flow state of the fluid to be dispensed and/or to distribute the flow to/from the longitudinal conduits.

According to the first aspect of the present invention, the inlet and the outlet of the fluid chamber may be fluidly connected by a plurality of longitudinal conduits radially distributed around the fluid cylinder. Said radial distribution may, or may not, be uniform. Said longitudinal conduit may be a hole.

According to the first aspect of the present invention, the inlet and the outlet of the fluid chamber may be fluidly connected by one or more curved slotted longitudinal holes.

According to the first aspect of the present invention, the fluid cylinder may be configured to drive an axially arranged valve stem for opening and closing the fluid outlet by axial movement thereof, the valve stem extending into the fluid passage. Preferably, the valve stem has a valve seat that, in a closed state of the fluidly actuated valve, obstructs the fluid outlet.

According to the first aspect of the present invention, the device for dispensing liquid may further comprise a dispensing tip of a certain length, said dispensing tip being arranged downstream of the fluid chamber, a dispensing section of the fluid passage extending from a proximal end to a distal end of the dispensing tip, the fluid outlet being arranged at the distal end of the dispensing tip.

According to the first aspect of the present invention, the dispensing tip may be attached to the elongated body by the proximal end thereof.

According to the first aspect of the present invention, the dispensing tip may be removably attached to the elongated body. Preferably, the dispensing tip is screwed to the elongated body, although other types of non-permanent union between the dispensing tip and the elongated body are also possible. The dispensing tip may also be permanently attached to the elongated body.

According to the first aspect of the present invention, the fluid passage, at the distal end of the dispensing tip, may be tapered towards the fluid outlet.

According to the first aspect of the present invention, the device may further comprise a dispensing tip of a certain length, said dispensing tip being arranged downstream of the fluid chamber, a dispensing section of the fluid passage extending from a proximal end to a distal end of the dispensing tip, the fluid outlet being arranged at the distal end of the dispensing tip; and the valve stem comprising a guide for guiding its axial movement along the dispensing section of the fluid passage.

According to the first aspect of the present invention, the valve closing inlet and/or the valve opening inlet may be radially arranged.

According to the first aspect of the present invention, the valve closing inlet and/or the valve opening inlet may be fluidly connected to a radially or an axially arranged connection port.

According to a second aspect of the present invention, it is also disclosed a method for dispensing liquid to water soluble pouches comprising the steps of: providing a device for dispensing liquid according to the first aspect of the present invention; supplying a liquid to the device for dispensing liquid via its fluid inlet while the fluid outlet is closed by the fluidly actuated valve; opening the fluid outlet with the fluidly actuated valve; dispensing liquid to a water-soluble pouch; and closing the fluid outlet with the fluidly actuated valve.

According to the second aspect of the present invention, the step of dispensing liquid to a water-soluble pouch may comprise the step of dispensing liquid to a compartment of a multicompartment water-soluble pouch.

According to the second aspect of the present invention, the method may further comprise the step of closing, i.e. sealing, the water-soluble pouch.

According to a third aspect of the present invention, it is also disclosed a cluster of two or more devices for dispensing liquid to water soluble pouches according to the first aspect of the present invention, comprising two or more adjacent devices for dispensing liquid, wherein the dispensing tip of at least two devices has a different length, so that the elongated body of a device is arranged above or below the elongated body of an adjacent device. The third aspect of the present invention is particularly advantageous when filling multicompartment water-soluble pouches as in this application is typically necessary to cluster or nest one device for filing each compartment. In such application, the reduced footprint of each individual device for dispensing liquid, together with the possibility to place their elongated bodies at different heights so that the elongated bodies of adjacent dispensing devices can be placed closer to one another, thereby reducing the overall footprint of the cluster of dispensing devices, is particularly advantageous.

According to the third aspect of the present invention, the horizontal projection or footprint of the elongated body of adjacent devices for dispensing liquid may partially overlap. By arranging the elongated bodies of adjacent devices so that their footprints partially overlap, the footprint of the cluster is further reduced.

According to the third aspect of the present invention, the cluster may also comprise dispensing devices different than the ones object of the first aspect of the present invention, for example, the cluster may also comprise devices for dispensing powdered material or solids, together with devices for dispensing liquid according to the first aspect of the present invention.

According to a fourth aspect of the present invention, it is also disclosed a machine for forming and filling pouches made of water-soluble film, the machine comprising a device for dispensing liquid according to the first aspect of the present invention.

According to the fourth aspect of the present invention, the machine for forming and filling pouches may comprise a cluster of two or more devices for dispensing liquid according to the third aspect of the present invention.

According to the fourth aspect of the present invention, the machine may be of a flatbed type or of a rotary type. The rotary type is also known as the drum type.

It will be understood that references to geometric position, such as parallel, perpendicular, tangent, etc. allow deviations up to ±5° from the theoretical position defined by this nomenclature.

It will be understood that longitudinal axis refers to an imaginary line that runs the length of an object, for example, a device for dispensing liquid, through the center thereof.

It will be understood that an axial direction refers to a direction or orientation that is along the longitudinal axis of the device for dispensing liquid, running through the center thereof from one end to the other.

It will be understood that a radial direction refers to a direction or orientation that extends outward from or inward towards the longitudinal axis of the device for dispensing liquid.

It will be understood that radially distributed refers to a configuration in which components, features, or elements are arranged in a pattern that extends outward from a central axis or point in a circular or cylindrical shape.

Throughout this document, the expressions ‘dispensing device’ and ‘device for dispensing’, and their corresponding plurals, are equivalent and are used interchangeably.

In the present document references to a proximal and a distal end are made following the stream of the fluid to be dispensed. In other words, a proximal end refers to an end arranged upstream and a distal end refers to an end arranged downstream.

The expression fluid cylinder should be understood as fluidly actuated cylinder, referring to a cylinder that is actuated by either a pressurized liquid or a pressurized gas.

In this document, the one or more longitudinal conduits are considered to be part of the fluid chamber.

It will also be understood that any range of values given may not be optimal in extreme values and may require adaptations of the invention to these extreme values are applicable, such adaptations being within reach of a skilled person.

### BRIEF DESCRIPTION OF THE FIGURES

The foregoing and other advantages and features will be more fully understood from the following detailed description of an embodiment with reference to the accompanying drawings, to be taken in an illustrative and non-limitative manner, in which:

FIG. 1 shows a perspective view of an exemplary embodiment of a device for dispensing liquid to a water-soluble pouch according to the present invention.

FIG. 2 shows a first section view of the exemplary embodiment of a device for dispensing liquid shown in FIG. 1.

FIG. 3 shows a second section view of the exemplary embodiment of a device for dispensing liquid shown in FIGS. 1 and 2.

FIG. 4 shows a top view of the elongated body of the exemplary embodiment of a device for dispensing liquid shown in FIGS. 1 to 3.

FIG. 5 shows a perspective sectioned view of the elongated body shown in FIG. 4.

FIG. 6 shows a perspective view of the exemplary embodiment of a device for dispensing liquid shown in FIGS. 1 to 5 without its dispensing tip.

FIG. 7 shows a perspective view of a first and a second exemplary embodiments of a cluster of two or more devices for dispensing liquid according to the present invention.

FIG. 8 shows a front view the exemplary embodiments of a cluster of two or more devices for dispensing liquid shown in FIG. 7.

FIG. 9 shows a top view of the exemplary embodiments of a cluster of two or more devices for dispensing liquid shown in FIGS. 7 and 8.

### DETAILED DESCRIPTION

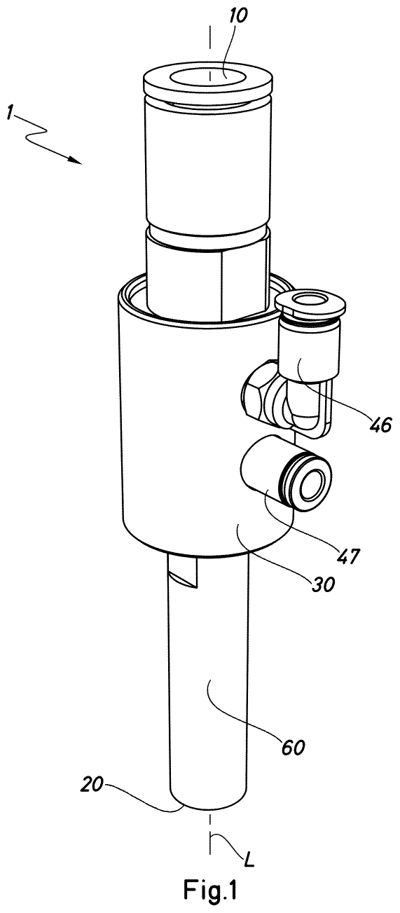

FIG. 1 shows a perspective view of an exemplary embodiment of a device for dispensing liquid to a water-soluble pouch according to the present invention. The device 1 for dispensing liquid to a water-soluble pouch, or simply, the device 1, has been depicted together with its longitudinal axis L that will be used as a reference for alignment, measurements, arrangement of features, etc. in relation to it.

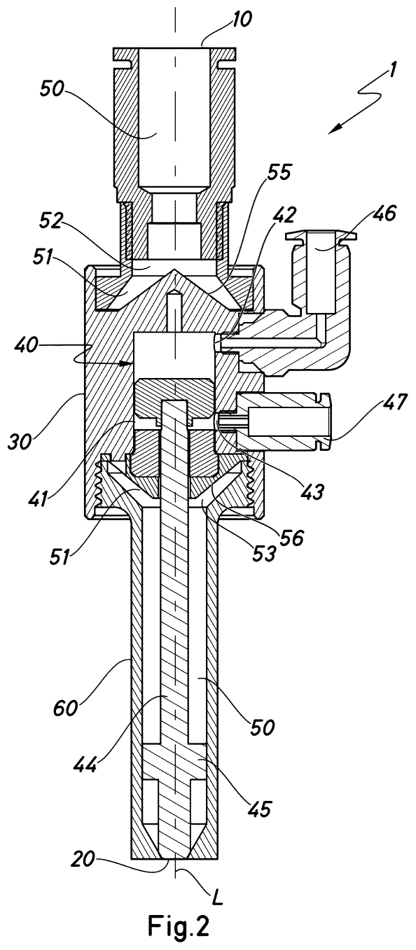

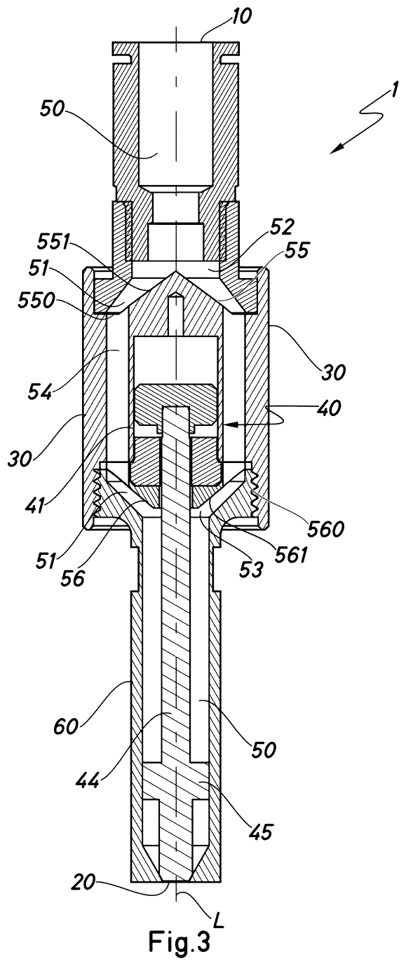

In the perspective view shown in FIG. 1 besides the already mentioned longitudinal axis L, it is also depicted the fluid inlet 10, the elongated body 30 housing the fluid cylinder 41 (see FIGS. 2 and 3) and the dispensing tip 60 of the dispensing device 1. Although it is hidden due to the perspective used, the fluid outlet 20 is also marked at the distal end of the dispensing tip 60.

Protruding from the elongated body 30, the exemplary embodiment shown comprises a connection port 46 of the valve closing inlet 42 and a connection port 47 of the valve opening inlet 43 (see, for example, FIG. 2). As can be seen, in this exemplary embodiment, the connection port 46 of the valve closing inlet 42 is arranged axially, i.e., with its longitudinal axis parallel to the longitudinal axis L of the device 1, and the connection port 47 of the valve opening inlet 43 is arranged radially, i.e., with its longitudinal axis perpendicular to the longitudinal axis L of the device 1. In other embodiments the configuration of the connection ports 46, 47, if present, may be different.

FIGS. 2 and 3 show a first and a second section view, respectively, of the exemplary embodiment of a device 1 for dispensing liquid shown in FIG. 1. In FIG. 2, the cutting plane contains the longitudinal axis L of the dispensing device 1 and the longitudinal axes of both the valve closing inlet 42 and the valve opening inlet 43, whereas in FIG. 3 the cutting plane is perpendicular to that of FIG. 2. These section views allow to clearly see the arrangement of the internal components of this exemplary embodiment of a device 1 for dispensing liquid according to the present invention.

A fluid passage 50 extending from the fluid inlet 10 to the fluid outlet 20 is arranged axially with respect to the longitudinal axis L of the device 1, which eases in maintaining a laminar flow of the liquid to be dispensed as sharp turns of the fluid are avoided and reduces the pressure drop in the fluid passage 50. This differs from conventional devices for dispensing liquid into water soluble pouches wherein the liquid to be dispensed is typically provided radially, i.e. perpendicular, to the longitudinal axis of the device, thereby creating a sharp bend, typically of about 90 degrees, which increases the pressure drop of the fluid passage and increases the difficulty to maintain laminar flow of the liquid to be dispensed.

In this exemplary embodiment, the fluid passage 50 comprises a dispensing section that extends from a proximal end of the dispensing tip 60 to a distal end of the dispensing tip 60 where the fluid outlet 20 is located.

The fluid passage 50 defines a fluid chamber 51, which is also axially arranged and encloses the fluid cylinder 41. In the exemplary embodiment shown, the fluid chamber 51 comprises an inlet 52 and an outlet 53 which are fluidly connected by a plurality of longitudinal conduits 54. In other embodiments, a single longitudinal conduit 54 could suffice. The fluid chamber 51 substantially surrounds the fluid cylinder 41, providing the technical effect of cooling the fluid cylinder 41 as the fluid to be dispensed flows through the fluid passage 50 and the fluid chamber 51 substantially surrounding the fluid cylinder 41, thereby cooling it. As the devices for dispensing liquid in water-soluble pouches usually operate at high speeds, the fluidly actuated valve 40 needs to operate at high speeds, thereby generating heat due to friction of components, compression of fluid, etc. The heat generated by the operation of the fluidly actuated valve 40 reduces the lifespan of its components, in particular, of the seals, thereby increasing its maintenance requirements. As the device 1 object of the present invention cools the fluidly actuated valve 40, and in particular, its fluid cylinder 41, with the liquid to be dispensed, the components of the fluidly actuated valve 40 remain at a lower temperature, even if operating at the same or higher speeds than other similar devices known in the art, thereby increasing the lifespan of its components, increasing maintenance intervals, etc. among other benefits.

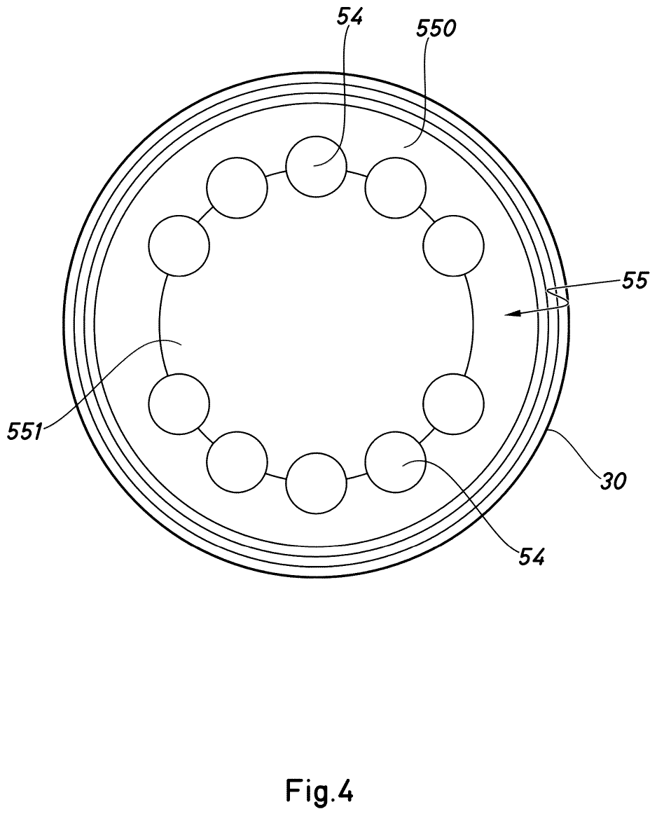

As can be seen in greater detail in FIG. 4, the exemplary embodiment shown comprises ten longitudinal conduits 54, arranged in two groups of five longitudinal conduits 54 each. In particular, in this exemplary embodiment the longitudinal conduits 54 extend from an upstream facing surface 55 to a downstream facing surface 56.

The upstream facing surface 55 distributes or guides the flow of the fluid to be dispensed towards the longitudinal conduits 54 and the downstream facing surface 56 guides the flow of the fluid coming from the longitudinal conduits 54 to the dispensing tip 60, and, in the particular embodiment shown, towards the dispensing section of the fluid passage 50. As can be seen, the section of both the upstream facing surface 55 and the downstream facing surface 56 are symmetrical with respect to the longitudinal axis L. In this exemplary embodiment, both the upstream facing surface 55 and the downstream facing surface 56 comprise a protruding region 551, 561 axially arranged, i.e., centered, with respect to the longitudinal axis L surrounded by a flat region 550, 560 arranged substantially perpendicular to the longitudinal axis L. In this exemplary embodiment, the protruding region 551 of the upstream facing surface 55 is conically shaped and the protruding region 561 of the downstream facing surface 56 is frustoconically shaped. In other embodiments, the upstream facing surface 55 and the downstream facing surface 56 may have different configurations. For example, either one of the two, or both, can comprise a protruding region 551, 561 or a flat region 550, 560 that extends over the entire surface 55, 56.

In this exemplary embodiment, the upstream facing surface 55 is integral with the elongated body 30, whereas the downward facing surface 56 is defined by an additional element or insert fixed to the longitudinal body 30. Therefore, in this exemplary embodiment, a first section of the longitudinal conduit 54 extends through the elongated body 30 and a second section of the longitudinal conduit 54 extends through the insert. In other embodiments this can be different, as for example, with both the upstream facing surface 55 and the downstream facing surface 56 being integral with the elongated body 30.

Both the upstream facing surface 55 and the downstream facing surface 56 are seen in greater detail in FIGS. 4 to 6.

The fluidly actuated valve 40, and in particular, its fluid cylinder 41, of the exemplary embodiment shown, has its valve closing inlet 42 and its valve opening inlet 43 radially arranged, as this simplifies the construction and complexity of the device and does not significantly affect the functioning of the device 1, in particular, does not significantly affect the flow of the fluid to be dispensed along the fluid passage 50. However, in other embodiments the valve closing inlet 42 and the valve opening inlet 43 may be arranged differently.

As in similar fluidly actuated valves known in the art, the fluidly actuated valve 40 is opened by providing pressurized fluid to the fluid cylinder 41 via the valve opening inlet 43 and is closed by providing pressurized fluid to the fluid cylinder 41 via the valve closing inlet 42.

In this exemplary embodiment, the pressurized fluid is air and, in particular, compressed air, and thus, the fluidly actuated valve 40 is a pneumatically actuated valve and the fluid cylinder 41 is a pneumatic cylinder. In other embodiments, the pressurized fluid can be a gas other than air or a liquid, for example, hydraulic oil.

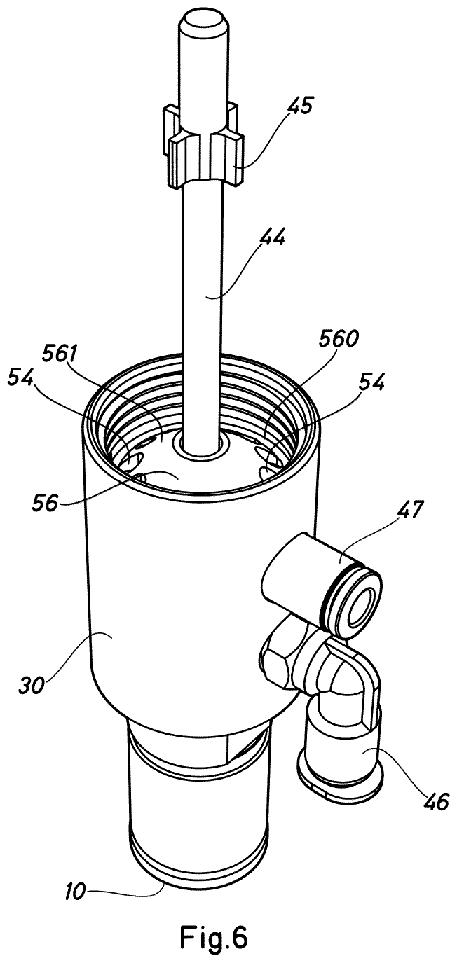

In the exemplary embodiment shown, the fluid cylinder 41 is configured to drive an axially arranged valve stem 44 for opening and closing the fluid outlet 20 by axial movement of said valve stem 44. Said valve stem 44 extends into the fluid passage 50 to the fluid outlet 20. In order to guide the movement along a dispensing section of the fluid passage 50 that extends from the proximal to the distal end of the dispensing tip 60, the valve stem 44 of the exemplary embodiment shown comprises a guide 45. The shape of the guide 45 of this exemplary embodiment can be seen in greater detail in FIG. 6.

In other embodiments the pneumatically actuated valve 40 may be of a different type, for example, without a valve stem 44, or the valve stem 44 may be arranged in a different manner than that of the exemplary embodiment shown.

In this exemplary embodiment, the dispensing tip 60, which is arranged downstream of the fluid chamber 51, is removably attached to the elongated body 30 and, in particular, the proximal end of the dispensing tip 60 is screwed into the distal end of the elongated body 30.

Other embodiments having a dispensing tip 60, may have a different configuration than the one shown in this exemplary embodiment. For example, in other embodiments having dispensing tip 60, the dispensing tip 60 may be attached to the elongated body 30 in another removable manner, or may be permanently attached to it.

FIG. 4 shows a top view of the elongated body 30 of the exemplary embodiment of a device 1 shown in FIGS. 1 to 3. This top view clearly shows the plurality of longitudinal conduits 54 of this exemplary embodiment that are arranged symmetrically in two groups of five longitudinal conduits 54 each. This arrangement provides a substantially uniform flow of fluid to be dispensed around the fluid cylinder 41 thereby providing effective cooling of the fluid cylinder 41. Other embodiments can have a different configuration of longitudinal conduits 54. For example, each group of a plurality of longitudinal conduits 54 could be substituted by a curved slotted longitudinal hole or all then longitudinal conduits 54 could be substituted by a C shaped curved slotted hole. Other possible configurations include a different number of longitudinal conduits 54, wherein a single one, if properly dimensioned, could suffice.

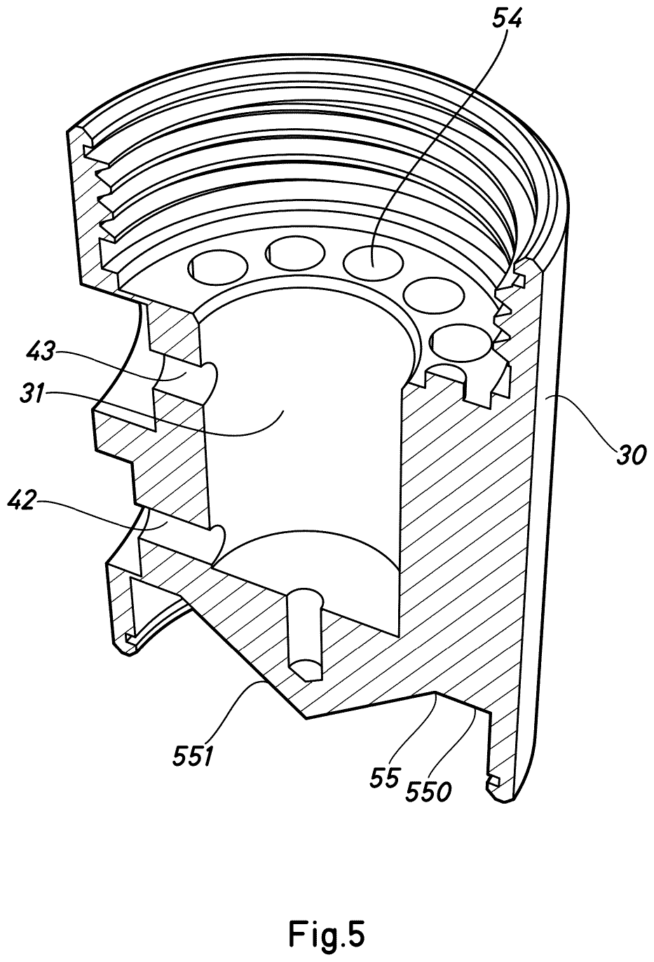

FIG. 5 shows a perspective sectioned view of the elongated body 30 shown in FIG. 4 upside down, or in other words, with its distal or downstream end pointing upwards, allowing visibility of elements that would otherwise be hidden. In this view can be seen the distal end of the portions of the longitudinal conduits 54 that extend through the elongated body 30. As previously described in the context of FIGS. 2 and 3, in this exemplary embodiment the longitudinal conduits 54 continue through the insert (not depicted) that defines the downstream facing surface 56 (see FIGS. 2, 3 and 6). However, other embodiments could lack such insert and what is seen in FIG. 5 could effectively be the downstream end of the longitudinal conduit 54.

The section view of FIG. 5 also shows the housing 31 of the fluid cylinder 41 of the fluidly actuated valve 40, as well as the valve closing inlet 42 and the valve opening inlet 43 previously described.

FIG. 6 shows a perspective view of the exemplary embodiment of a device 1 for dispensing liquid shown in the previous figures, but upside down and with its dispensing tip 60 removed, allowing visibility of elements that otherwise would not be seen. This figure clearly shows the shape of the guide 45 of the valve stem 44 of this exemplary embodiment, which is substantially cross-shaped providing sufficient guidance to the valve stem 44, but at the same time allowing good flowability of the liquid to be dispensed along the fluid passage 50 and, in particular, the dispensing section of the fluid passage 50.

This figure also shows the frustoconically shaped protruding region 561 and the flat region 560 of the downstream facing surface 56.

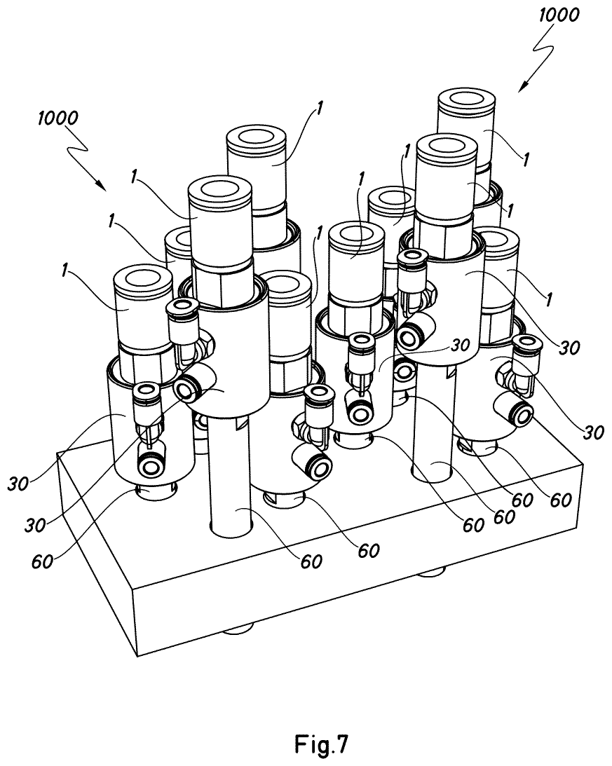

FIGS. 7, 8 and 9 show, respectively, a perspective, a front and a top view of a first and a second exemplary embodiments of a cluster 1000 of two or more devices 1 for dispensing liquid according to the present invention. Both exemplary embodiments of a cluster 1000 according to the present invention comprise five devices 1 for dispensing liquid according to the first aspect of the present invention. In other embodiments of clusters 1000 according to the present invention, the number of devices 1 may be different, for example, two, three, four, six, etc.

The angular position of each device 1 of the cluster 1000 is the one that allows easier connection with the supply lines of the fluid to be dispensed and the pressurized fluid that drives the fluidly actuated valve 40 of each device 1. For illustrative purposes, said supply lines have been omitted in FIGS. 7 to 9.

As can be seen, the reduced footprint of each device 1 for dispensing liquid, as well as its configuration allows the cluster 1000 to comprise a great number of devices 1 in a reduced area, thereby easing filling of multicompartment water-soluble pouches with complex geometries.

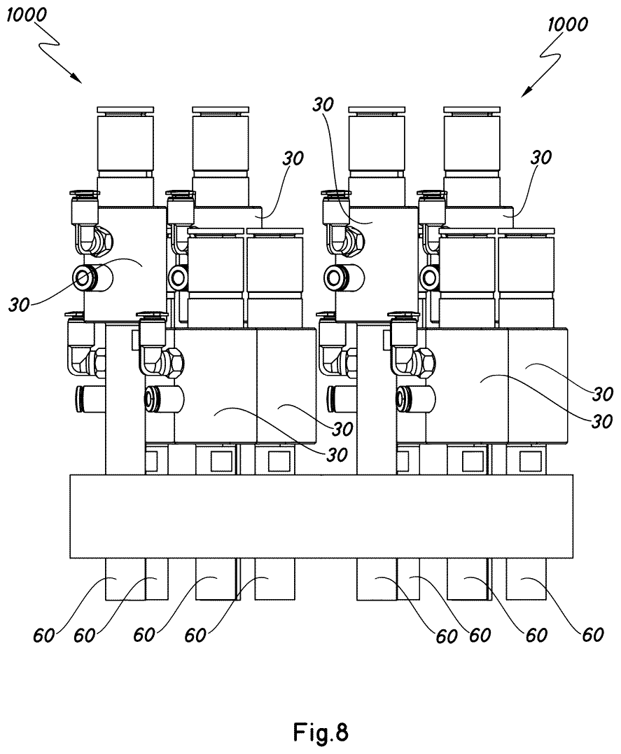

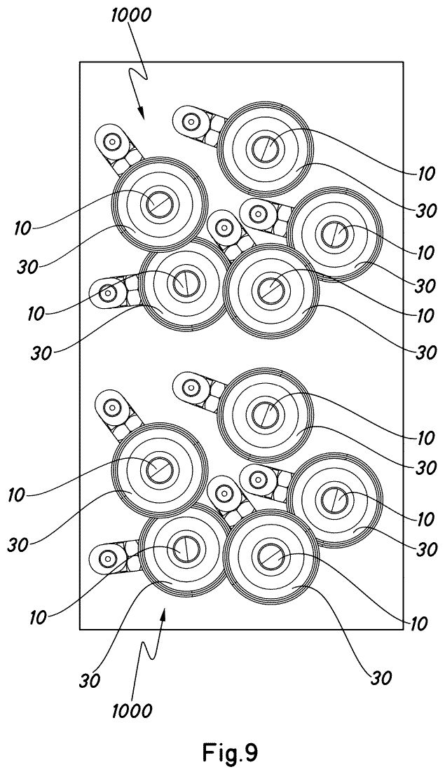

Besides with the reduced footprint of each individual device 1 for dispensing liquid, the reduced footprint of the cluster 1000 is also achieved by providing devices 1 in each cluster 1000 with a dispensing tip 60 of a different length, an in particular, with a length that allows the elongated body 30 of a device 1 to be placed above or below the elongated body 30 of an adjacent device 1, allowing a partial overlap of the horizontal projection or footprint of the elongated bodies 30 of adjacent devices 1. This can clearly be seen in FIGS. 8 and 9. However, it is also possible to nest or cluster devices 1 having a dispensing tip 60 with the same length, although in this case the footprint of the cluster 1000 will be greater as in this case it is not possible to arrange the elongated bodies 30 at different heights and with a partial overlap between them. It is also possible to arrange the elongated bodies 30 at different heights by using dispensing tips 60 of different length, but without partial overlap of the footprint of the elongated bodies 30.

The clusters 1000 shown are held in a dummy support for illustrative purposes. However, it should be understood that these clusters 1000 are envisaged to be arranged, preferably, in a machine for forming and filling pouches made of water-soluble film, which may be of the flatbed or rotary type. The rotary type is also known as the drum type. The same applies to a device 1 for dispensing liquid according to the present invention.

Taking into account the disclosure of the present document, the installation of either a device 1 or a cluster 1000 according to the present invention in a machine for forming and filling pouches made of water-soluble film is considered obvious for a person skilled in the art.

According to a second aspect, the present invention also relates to a method for dispensing liquid to water soluble pouches comprising the steps of:
providing a device 1 for dispensing liquid according to the first aspect of the present invention;
supplying a liquid to the device 1 for dispensing liquid via its fluid inlet 10 while the fluid outlet 20 is closed by the fluidly actuated valve 40;
opening the fluid outlet 20 with the fluidly actuated valve 40;
dispensing liquid to a water-soluble pouch; and
closing the fluid outlet 20 with the fluidly actuated valve 40.

In case of multicompartment water-soluble pouches, the device 1 dispenses liquid to a single compartment of the water-soluble pouches.

Although the invention has been presented and described with reference to embodiments thereof, it should be understood that said embodiments do not limit the invention, and therefore many structural or other details which may be obvious to persons skilled in the art after interpreting the subject matter disclosed in the present description, claims and drawings, may vary. In particular, in principle and unless explicitly stated otherwise, all features of each of the different embodiments and alternatives shown and/or suggested may be combined with one another. Thus, all variants and equivalents are included within the scope of the present invention if they can be considered to fall within the widest scope of the following claims.

1. A device for dispensing liquid to a water-soluble pouch comprising:
a fluid inlet;
a fluid outlet;
an elongated body defining a longitudinal axis of the device, the elongated body comprising a fluid passage therein extending from the fluid inlet to the fluid outlet;
a fluidly actuated valve for opening and closing the fluid outlet, the valve comprising:
a fluid cylinder housed in the elongated body,
a valve closing inlet, and
a valve opening inlet;
the fluid inlet, the fluid passage, the fluid cylinder and the fluid outlet are axially arranged with respect to a longitudinal axis; and
the fluid passage defines a fluid chamber comprising an inlet and an outlet configured to enclose the fluid cylinder.

2. The device according to claim 1, wherein the inlet and the outlet of the fluid chamber are fluidly connected by one or more longitudinal conduits arranged around the fluid cylinder.

3. The device according to claim 2, wherein the fluid chamber comprises an upstream facing surface and a downstream facing surface, the one or more longitudinal conduits extending from the upstream facing surface to the downstream facing surface.

4. The device according to claim 3, wherein either or both of the upstream facing surface and the downstream facing surface comprises a flat region arranged substantially perpendicular to the longitudinal axis.

5. The device according to claim 4, wherein either or both of the upstream facing surface and the downstream facing surface comprises a protruding region axially arranged with respect to the longitudinal axis.

6. The device according to claim 5, wherein the protruding region is conically or frustoconically shaped.

7. The device according to claim 2, wherein the inlet and the outlet of the fluid chamber are fluidly connected by a plurality of longitudinal conduits radially distributed around the fluid cylinder.

8. The device according to claim 2, wherein the inlet and the outlet of the fluid chamber are fluidly connected by one or more curved slotted longitudinal holes.

9. The device according to claim 1, wherein the fluid cylinder is configured to drive an axially arranged valve stem for opening and closing the fluid outlet by axial movement thereof, the valve stem extending into the fluid passage.

10. The device according to claim 1, further comprising a dispensing tip comprising a predetermined length, the dispensing tip being arranged downstream of the fluid chamber, a dispensing section of the fluid passage extending from a proximal end to a distal end of the dispensing tip, the fluid outlet being arranged at the distal end of the dispensing tip.

11. The device, according to claim 10, wherein the dispensing tip is attached to the elongated body by the proximal end thereof.

12. The device according to claim 10, wherein the fluid passage is tapered towards the fluid outlet at the distal end of the dispensing tip.

13. The device according to claim 10, further comprising: a dispensing tip comprising a predetermined length and being arranged downstream of the fluid chamber, and a dispensing section of the fluid passage extending from a proximal end to a distal end of the dispensing tip; the fluid outlet being arranged at the distal end of the dispensing tip; and the valve stem comprising a guide for guiding its axial movement along the dispensing section of the fluid passage.

14. The device, according to claim 1, wherein either or both of the valve closing inlet and the valve opening inlet are radially arranged.

15. The device, according to claim 14, wherein either or both of the valve closing inlet and the valve opening inlet are fluidly connected to a radially or an axially arranged connection port.

16. A cluster of two or more devices for dispensing liquid to water soluble pouches according to claim 10, each of the devices of the cluster comprising a substantially equivalent structure, wherein the dispensing tip of at least two devices of the cluster has a different length, so that the elongated body of a device is arranged above or below the elongated body of an adjacent device of the cluster.

17. A method for dispensing liquid to water soluble pouches comprising:
providing a device for dispensing liquid to a water soluble pouch, the device comprising:
a fluid inlet;
a fluid outlet;
an elongated body defining a longitudinal axis of the device, the elongated body comprising a fluid passage therein extending from the fluid inlet to the fluid outlet;
a fluidly actuated valve for opening and closing the fluid outlet, the valve comprising:
a fluid cylinder housed in the elongated body,
a valve closing inlet, and
a valve opening inlet;
the fluid inlet, the fluid passage, the fluid cylinder and the fluid outlet are axially arranged with respect to a longitudinal axis; and
the fluid passage defines a fluid chamber comprising an inlet and an outlet configured to enclose the fluid cylinder;
supplying a liquid to the device for dispensing liquid via the fluid inlet while the fluid outlet is closed by the fluidly actuated valve;
opening the fluid outlet with the fluidly actuated valve;
dispensing liquid to the water-soluble pouch; and
closing the fluid outlet with the fluidly actuated valve.

18. The method, according to claim 17, wherein dispensing liquid to the water-soluble pouch comprises dispensing liquid to a compartment of a multicompartment water-soluble pouch.

19. A machine for forming and filling pouches made of water-soluble film, the machine comprising a device for dispensing liquid to a water soluble pouch, the device comprising:
a fluid inlet;
a fluid outlet;
an elongated body defining a longitudinal axis of the device, the elongated body comprising a fluid passage therein extending from the fluid inlet to the fluid outlet;
a fluidly actuated valve for opening and closing the fluid outlet, the valve comprising:
a fluid cylinder housed in the elongated body,
a valve closing inlet, and
a valve opening inlet;
the fluid inlet, the fluid passage, the fluid cylinder and the fluid outlet are axially arranged with respect to a longitudinal axis; and
the fluid passage defines a fluid chamber comprising an inlet and an outlet configured to enclose the fluid cylinder.

20. The machine according to claim 19 furhter comprising comprising a cluster of two or more devices for dispensing liquid into a water soluble pouch, each one of the cluster of two or more devices having a substantially equivalent structure and comprising:
a dispensing tip comprising a predetermined length, the dispensing tip being arranged downstream of the fluid chamber; and
a dispensing section of the fluid passage extending from a proximal end to a distal end of the dispensing tip, the fluid outlet being arranged at the distal end of the dispensing tip; and
the dispensing tip of at least two devices of a cluster comprising a different length, such that the elongated body of a device is arranged above or below the elongated body of an adjacent device of the cluster.
